(19) United States
(12) Patent Application Publication
(10) Pub. No.: US 2026/0356635 A1
(43) Pub. Date: Nov. 12, 2026

(54) ELEVATOR SYSTEM, METHOD FOR PRODUCING AN ELEVATOR SYSTEM

(71) Applicant: INVENTIO AG, Hergiswil (CH)

(72) Inventors: Massimiliano Visintin, Zürich (CH); Hans-Rudolf Hammer, Ebikon (CH)

(21) Appl. No.: 19/515,871

(22) PCT Filed: Aug. 27, 2024
(86) PCT No.: PCT/EP2024/073927

§ 371 Date: Mar. 3, 2026

(30) Foreign Application Priority Data
Sep. 6, 2023 (EP) 23195614.5

(51) Int. Cl. B66B 11/04; H02K 1/16; H02K 9/22; H02K 15/026

(52) U.S. Cl. CPC B66B 11/043; H02K 1/16; H02K 9/227; H02K 15/026

(57) ABSTRACT

An elevator system comprising an elevator shaft, a car, and at least one counterweight, which are arranged in the elevator shaft and coupled to one another via at least one support means; at least one elevator drive; wherein the at least one support means runs over the elevator drive such that the support means is movable by means of the elevator drive, so that the elevator car and the at least one counterweight are vertically displaceable by operating the elevator drive. The system further comprises a brake by means of which the elevator car and/or the counterweight can be braked and/or locked.

### TECHNICAL FIELD

The present invention relates to an elevator system having at least one elevator drive.

### BACKGROUND

Elevator systems are used in many applications in buildings and factories for the transport of goods or people. Such elevator systems must be reliable and durable. In order to reduce installation and maintenance time and costs, it is advantageous if the components of the elevator system are as light and small as possible, or do not exceed a certain weight/size.

Known elevator systems for transporting people or loads include an elevator car which can be moved vertically in an elevator shaft. The elevator car is usually connected to a counterweight via a support means. A drive for moving the elevator car along a guide rail can be arranged, for example, on a drive assembly in a shaft head of the elevator shaft or in a machinery room above the elevator shaft.

Elevator systems have an elevator drive, which includes a stator, a rotor, a series of mechanical components that hold the stator and rotor together, and a cooling system. The stator generally comprises metal sheets stacked one over the other that can be joined together by lamination. In addition, the stator can have slot-shaped winding receptacles into which a stator winding can be inserted. The stator winding can for example be formed as an alternating current winding. Similar to the stator, the rotor can comprise multiple metal sheets, in particular iron sheets, stacked one over the other, which can also be joined together by lamination. Alternatively, the rotor can be designed as a solid, in other words one-piece, component, i.e., as a non-laminated rotor. The rotor can be equipped with either an AC or DC winding, or with permanent magnets and/or specific flux barriers (reluctance machines). The mechanical components can be a mechanical structure that holds the stator and rotor together and enables the rotor to rotate about an axis of rotation of the elevator drive.

The cooling system allows thermal losses in the form of heat generated during operation of the elevator drive to be dissipated in order to keep the components mentioned above below the corresponding permissible temperature limits. These limits can depend on the materials used for these components and their properties and/or can be specified by specific standards or operating limits.

The most common design used for elevator drives requires an external frame, in other words a housing, to house the stator and rotor and to provide the required rigidity and general IP protection. In these cases, the frame can consist of multiple supports that are connected to the stator via special mechanical interfaces. In these cases, a special heat exchanger can be provided through which an exchange of heat takes place between the internal and external cooling means of the elevator drive.

For smaller, more compact elevator drives, the frame can consist of a steel cylinder that can have multiple cooling fins on its outside. In this case, a tight fit between the stator and the frame can ensure that the thermal losses generated by the elevator drive can be dissipated to the environment. The cooling fins increase the surface area for the heat exchange, and thus improve the cooling effect. The heat transfer from the frame to an environment of the elevator drive, in particular to the air surrounding the elevator drive, can be achieved either by means of forced ventilation, in particular using one or more fans that direct the air flow to the cooling fins, or by natural convection.

For more compact elevator drives, in particular those that are short in the direction of the axis of rotation, other, simplified designs can be used, in particular so-called frameless designs, in particular frameless stators. These designs do not require a special housing surrounding the stator, thus reducing overall costs. In applications where the total length of the stator and rotor in the direction of the axis of rotation is limited, for example, to less than 1 m, such a frameless stator can be fixed to a base with multiple screws, where the screws can be inserted into support structures on an outer surface of the frameless stator. Often there is also a second base on which bearings are arranged that support the rotor so as to be rotatable. However, cooling may be inadequate with these frameless stators because the housing with the corresponding cooling devices is not provided.

In the area of elevator systems, a relatively high drive torque is required over a wide rotational speed range. Therefore, frameless stators regularly require auxiliary fans to ensure the necessary cooling of the elevator drive at any operating speed. These auxiliary fans are operated by means of appropriate control circuits and their own small electric motors, which are powered by external energy sources.

Both the housing and the auxiliary fans contribute to the complex structure of classic elevator drives. This can lead to relatively high manufacturing costs and relatively time-consuming and/or costly maintenance work for the elevator drive, in particular compared to less complex elevator drives without a housing or without an auxiliary fan. In case of using auxiliary fans, the energy consumption of the elevator drive can be relatively high, which can have a negative impact on the sustainability of the elevator drive and lead to relatively high operating costs compared to the elevator drive without auxiliary fans.

Therefore, there may be a need for an improved elevator system. In particular, there may be a need for an elevator system with an elevator drive with a frameless stator that is simple in design, cost-effective to manufacture and/or operate, and/or easy to maintain. Furthermore, there may be a need for a method for producing such an elevator system that is simple and/or cost-effective to implement.

### SUMMARY

Such a need can be met by the subject matter of the present disclosure. Advantageous embodiments are defined in the following description, as well as the accompanying drawings.

A first aspect of the invention relates to an elevator system. The invention comprises an elevator system having: an elevator shaft; an elevator car arranged in the elevator shaft; at least one counterweight arranged in the elevator shaft and coupled to the elevator car via at least one support means; at least one elevator drive; wherein the at least one support means extends over the elevator drive in such a way that the support means is movable by means of the elevator drive, so that the elevator car and the at least one counterweight can be displaced vertically by operating the elevator drive; and a brake, by means of which the elevator car and/or the counterweight can be braked and/or locked.

According to one embodiment, the elevator drive has a stator not having a housing. The stator without housing comprises: a stator core having a stator recess for receiving a rotor of the elevator drive, and one or more cooling fins arranged on an outer surface of the stator core. In a further aspect, the present disclosure relates to an elevator drive according to the embodiment described above and/or below.

The stator not having a housing can also be called a “frameless stator.” The fact that the stator does not have a housing means that the stator is not arranged in a stator housing or housing of the elevator drive, which in turn is arranged on a corresponding base, but rather that the stator is arranged directly on the corresponding base and/or that the elevator drive does not have a housing, in particular no stator housing. The stator is accordingly preferably designed for direct mounting on a supporting structure, in particular a base, and contacts the supporting structure directly in the mounted state.

The cooling fins are designed to dissipate heat to a gaseous cooling medium that comes into direct contact with the stator, and in particular with the cooling fins. The gaseous cooling medium can in particular be air, in particular the ambient air surrounding the elevator drive. In the free space between each two adjacent cooling fins, a flow channel is formed through which the gaseous cooling medium can flow.

The stator core can for example have or consist of multiple metal layers, in particular metal sheets, for example iron sheets. The metal layers can each have a thickness in a range for example from 0.1 mm to 1 cm, for example from 0.3 mm to 0.65 mm. The metal layers can be separated from each other by dielectric layers to minimize eddy current losses induced by the magnetic alternating current. In the case of metal sheets, this can be achieved by applying an insulating varnish to both sides of the metal sheets. The metal layers each have a layer recess of the corresponding metal layer, wherein the layer recesses together form the stator recess for receiving the rotor. On a wall of the jointly formed recess, multiple winding receptacles, for example in the form of slots, can be formed for receiving one or more stator windings. In this context, the elevator drive, in particular the stator, can comprise the stator winding(s). The stator windings can also be referred to as coils and/or can comprise copper, in particular can be formed from insulated copper wires.

For example, end faces of the cooling fins remote from the stator core can each be at least 10 mm away from the stator core in the radial direction. Concretely, the cooling fins can each have a height of at least 10 mm. For example, the remote end faces of the cooling fins can each be at a distance from the rest of the stator core of between 10 mm and 100 mm, for example between 15 mm and 70 mm, for example between 20 mm and 50 mm. This helps to ensure sufficient cooling by the cooling fins. The end faces of the cooling fins form, at least in part, the outer contour or circumferential contour of the stator.

The elevator drive can be an electric motor or a generator, or can be operated in both motor and generator mode. The elevator drive can have a rotary shaft, such as a motor shaft or a generator shaft, which rotates about the axis of rotation. The rotor can be connected to the rotary shaft in a rotationally fixed manner. The rotary shaft, the rotor and/or the stator can be arranged concentrically to the axis of rotation. Furthermore, the rotor can have one or more windings, for example copper windings, in particular one or more rotor winding(s). These windings can be arranged and/or fixed in corresponding winding receptacles of the rotor.

A large part of the energy losses of the elevator drive are in the form of thermal losses, in particular heat. These thermal losses occur to a large extent in the stator, in particular in the stator core formed by the metal layers and in the stator windings fastened in the winding receptacles. The stator with the cooling fins has the effect that the heat is dissipated exactly where it is generated, making the cooling very efficient. This type of cooling is also largely independent of the current rotational speed of the elevator drive. Therefore, sufficient cooling of the elevator drive is guaranteed even at low speeds or when stationary. An orientation of the cooling fins can be adapted to a convection that otherwise occurs in the elevator drive and/or the environment of the elevator drive in order to create a particularly good air flow around the cooling fins and thus a particularly efficient cooling of the stator and thus of the elevator drive.

The elevator drive does not require the use of auxiliary fans due to the stator with cooling fins. In this way the design of the elevator drive can be simplified, and thus the overall costs can be reduced compared to an elevator drive with auxiliary fans. This allows energy consumption to be kept low over the entire service life of the elevator drive, which promotes the overall sustainability of the elevator drive. In addition, the complexity of the elevator drive with the frameless stator having the cooling fins is relatively low compared to an elevator drive with auxiliary fans and/or with a housing, in particular with a stator housing. Due to this relatively low complexity, the reliability of the elevator drive can be high, which means that the number of operational failures of the elevator drive can be low.

In elevator drives with a horizontal axis of rotation, the use of a frameless stator, which implies the absence of the housing, requires in most cases a limited axial length for the stator core, for example an iron core, of the stator, so that the stator can be suspended on only one side from a vertical support structure, for example a base, without this having a detrimental effect on the overall mechanical stability, the induced vibrations and/or the noise generated during operation of the elevator machine. In general, this is fulfilled if the length of the stator is limited to 1 m or less. However, the present invention can also be considered for longer stators, even if these require a more complex mechanical structure to support the stator core, for example two bases to which the stator core is attached on both axial sides of the stator. These designs can be used for various passenger transport systems, such as elevators, escalators, or moving walkways. However, the elevator drive with the frameless stator with cooling fins can also be used for applications where the axis of rotation of the elevator drive is vertically aligned.

According to one embodiment, the cooling fins are arranged directly on the stator core. This contributes to a particularly good and effective thermal coupling of the stator core and the cooling fins, and thus to a particularly efficient cooling of the stator and thus of the elevator drive. The fact that the cooling fins are arranged “immediately,” in other words “directly,” on the stator core means, for example, that there is no other body between the cooling fins and the stator core and/or that the cooling fins are formed integrally with the stator core, or at least integrally with one or more parts of the stator core.

According to one embodiment, the stator recess is rotationally symmetrical to the axis of rotation of the elevator drive and the cooling fins are designed and/or arranged such that they extend perpendicular to the axis of rotation. The cooling fins can, for example, extend in the circumferential direction of the stator. Alternatively, the cooling fins can extend in the axial direction or in a direction between the circumferential direction and the axial direction, depending on which embodiment provides a stronger flow around the cooling fins by the air in the vicinity of the elevator drive. Furthermore, the cooling fins can be arranged parallel to each other.

According to one embodiment, the stator core or at least parts of the stator core and the cooling fins are formed in one piece. In other words, the stator core or at least parts of the stator core and the cooling fins can be formed from one piece. This contributes to a particularly good and effective thermal coupling of the stator core to the cooling fins, and thus to a particularly efficient cooling of the stator and thus of the elevator drive.

According to one embodiment, the stator has multiple metal layers which together form the stator core and the cooling fins, the metal layers each have a layer recess, the metal layers are arranged alternately one behind the other in the direction of the axis of rotation such that the layer recesses are congruent with one another and together form the stator recess, at least every second one of the metal layers has, at least in some regions, a larger outer diameter than the corresponding adjacent metal layers, and the regions in which the metal layers have the larger outer diameter than the corresponding adjacent metal layers form the cooling fins. This makes it easy to form at least parts of the stator core, in particular the second metal layers, in one piece with the cooling fins. This contributes to particularly efficient heat dissipation from the stator core to the cooling fins. The metal layers can be part of the stator core. At least every second metal layer forms the cooling fins and is thus formed integrally with them. Thus, in this embodiment, the cooling fins are formed integrally with the stator core, in particular integrally with parts of the stator core.

In one embodiment, the cooling fins are continuously circumferential or substantially continuously circumferential relative to the axis of rotation. Furthermore, in one embodiment, a flow channel formed between each two adjacent cooling fins is continuously circumferential or substantially continuously circumferential with respect to the axis of rotation in the circumferential direction. This can be achieved in that the first metal fins, over the entire circumference or substantially over the entire circumference, have a than the second metal layers which form the cooling fins. In particular, “substantially” can mean for example at least 95%, at least 90%, or at least 80%.

Optionally, the metal layers can each have multiple continuous fastening recesses, which are designed and arranged such that they are arranged congruently one behind the other when the metal layers are arranged next to one another. If necessary, a fastening element, such as a screw or a pin, can be passed through the fastening recesses, for example to fasten the stator to the base. In the regions where the fastening recesses are formed, the first and second metal layers can have the same outer diameter. The regions in which the second metal layers have the larger outer diameter than the first metal layers and which form the cooling fins can then be arranged in the circumferential direction between the fastening recesses.

The regions in which the first and second metal layers have the same diameter can for example amount to a maximum of 5%, a maximum of 10% or a maximum of 20% in the circumferential direction. In one embodiment, the first metal layers have an upper diameter in the region of the fastening recesses and a lower diameter otherwise. The upper diameter can be a diameter of the second metal layers. A continuous transition or a step can be formed between the upper and lower diameter regions.

According to one embodiment, the metal layers are arranged immediately next to one another. In other words, it can be that no other components of the elevator drive are situated between the metal layers, in particular in the axial direction of the axis of rotation. This can contribute to a particularly good coupling between the metal layers. Alternatively, the dielectric layers mentioned above, in particular the insulating varnish, can be arranged between the metal layers.

According to one embodiment, the metal layers each comprise or are formed from multiple metal segments. Thus, the metal layers can each be composed of multiple metal segments. This can contribute to producing particularly little waste, in other words cutting waste, during the production process, in particular when cutting, punching or sawing out the metal layers. This can help to keep production costs for the metal layers and thus the stator and thus the elevator drive particularly low.

According to one embodiment, the metal segments of one of the metal layers are arranged offset in the circumferential direction relative to the metal segments of an adjacent one of the corresponding metal layers such that interfaces between the metal segments of one of the metal layers are offset relative to interfaces between the metal segments of the corresponding adjacent metal layer or metal layers. In other words, the metal segments can be arranged such that the interfaces between the metal segments of one of the metal layers are not arranged overlapping the interfaces between the metal segments of the corresponding adjacent metal layers. This can help ensure that the final assembled stator, in terms of its behavior, function and/or properties, is as close as possible to a stator whose stator core or whose metal layers are formed from one piece and does not have multiple metal layers or multiple metal segments.

According to one embodiment, the metal layers comprise first metal layers and second metal layers which are arranged alternately, the second metal layers have at least in some regions a larger outer diameter than the first metal layers, and the regions in which the second metal layers have the larger outer diameter than the first metal layers form the cooling fins. Thus, there may be at least two different types of metal layers, one type of these metal layers being the second metal layers and the second metal layers forming the cooling fins, in particular in the regions where the second metal layers have the larger outer diameter than the first metal layers. The second metal layers are parts of the stator core. The second metal layers form the cooling fins and are thus formed in one piece with them. Thus, in this embodiment, the cooling fins are formed integrally with the stator core, in particular integrally with parts of the stator core.

According to an embodiment with first and second metal layers, the first metal layers are identical or substantially identical to one another, and the second metal layers are identical or substantially identical to one another, wherein the first metal layers and the second metal layers are differently designed from one another. In particular, a circumferential contour of the first and second metal layers can be different in a top view or in a viewing direction parallel to the axis of rotation.

First metal layers and second metal layers can be arranged directly alternating or alternately along the axis of rotation, so that first metal layers and second metal layers follow one another directly in alternating fashion. In principle, however, it is also possible that groups of a number of first metal layers and second metal layers are arranged alternately one behind the other along the axis of rotation, where the number of metal layers can be the same or different.

According to one embodiment, the metal layers are identically formed and each have regions with a first outer diameter and regions with a second outer diameter, wherein the second outer diameter is larger than the first outer diameter, and the metal layers are arranged on one another such that the regions with the first outer diameters of one of the metal layers are arranged, in the direction of the axis of rotation, next to regions with the second outer diameters of a corresponding adjacent one of the metal layers, wherein the cooling fins are formed by the regions with the second outer diameters. Thus, the stator core can be formed from multiple similar metal layers which have the enlarged outer diameters only in individual outer regions, wherein these similar metal layers are then arranged offset from one another in such a way that the regions with enlarged outer diameters of one of the metal layers are each arranged in the axial direction next to regions with non-enlarged outer diameters of the corresponding adjacent metal layers. In this embodiment, too, the regions in which the metal layers have the larger outer diameter form the cooling fins. Furthermore, in this embodiment, the cooling fins are also formed integrally with parts of the stator core, in particular with the metal layers.

According to one embodiment, the rotor has multiple vanes arranged between the axis of rotation and an outer circumference of the rotor and designed to move air towards the stator. The rotor with the vanes can in particular be configured to act like a fan, which moves the air outwards towards the stator as the rotor rotates. This air can pass by the cooling fins and absorb heat from them. This can help increase the cooling efficiency of the cooling fins. The shape of the vanes and the orientation of the cooling fins can be coordinated such that the vanes can be used to achieve optimal air flow around the cooling fins.

A second aspect of the invention relates to a method for producing an elevator installation comprising an elevator drive with a housingless stator, the method comprising: providing multiple of the metal layers, each having one of the layer recesses; and arranging the metal layers one behind the other in the direction of the axis of rotation such that the layer recesses are congruent with one another and together form the stator recess for receiving the rotor of the elevator drive, wherein at least every second one of the metal layers has, at least in some regions, the larger outer diameter than the corresponding adjacent one of the metal layers, wherein the regions in which the metal layers have the larger outer diameter than the corresponding adjacent metal layers form the cooling fins of the stator, and the metal layers arranged adjacent to one another together form the stator core of the stator.

Features of the elevator system according to an embodiment of the first aspect of the invention can also be features of the method according to an embodiment of the second aspect of the invention, and vice versa.

According to one embodiment, the metal layers have first metal layers and second metal layers, which are arranged alternately when the metal layers are arranged one behind the other, the second metal layers have at least in some regions a larger outer diameter than the first metal layers, and the regions in which the second metal layers have the larger outer diameter than the first metal layers form the cooling fins.

According to one embodiment, the metal layers are identically formed and each have regions with a first outer diameter and regions with a second outer diameter, wherein the second outer diameter is larger than the first outer diameter, and when the metal layers are arranged one behind the other, the metal layers are arranged such that the regions with the first outer diameters of one of the metal layers are arranged, in the direction of the axis of rotation, next to regions with the second outer diameters of a corresponding adjacent one of the metal layers, wherein the cooling fins are formed by the regions with the second outer diameters.

The elevator drive is suitable for use in a passenger transport system, in particular to move a passenger transport device of the passenger transport system. The passenger transport system can be for example an elevator system, an escalator, or a moving walkway. Accordingly, the passenger transport device can comprise a elevator car of the elevator system, steps of the escalator or movable metal segments of the moving walkway. For example, in the case of the elevator system, the elevator car can be arranged so as to be vertically displaceable in an elevator shaft and the elevator drive can be arranged and designed so that the elevator car can be vertically displaced in the elevator shaft by the elevator drive, wherein the elevator drive is mechanically coupled to the elevator car via at least one support means.

### BRIEF DESCRIPTION OF THE DRAWINGS

Embodiments of the invention will be described below with reference to the accompanying drawings, wherein neither the drawings nor the description are intended to be interpreted as limiting the invention.

FIG. 1 shows a schematic lateral sectional view of an elevator system according to an embodiment of the invention;

FIG. 2 shows a schematic lateral sectional view of an elevator drive according to an embodiment of the invention;

FIG. 3 shows a perspective view of a stator for an elevator drive according to an embodiment of the invention;

FIG. 4 shows a perspective view of a stator for an elevator drive according to an embodiment of the invention;

FIG. 5 shows a perspectival detail view of a stator according to an embodiment of the invention;

FIG. 6 shows a perspective view of a first metal segment of a first metal layer of the stator according to FIG. 4;

FIG. 7 shows a perspective view of an embodiment of a second metal segment of a second metal layer of the stator according to FIG. 4;

FIG. 8 shows a schematic lateral sectional view of an elevator drive according to an embodiment of the invention;

FIG. 9 shows a flow chart of an embodiment of a method for producing a stator according to an embodiment of the invention; and

FIG. 10 shows a flow chart of an embodiment of a method for producing a stator according to an embodiment of the invention.

The drawings are merely schematic and are not to scale. In the different figures, identical reference signs denote identical or similar features.

### DETAILED DESCRIPTION OF THE EMBODIMENTS

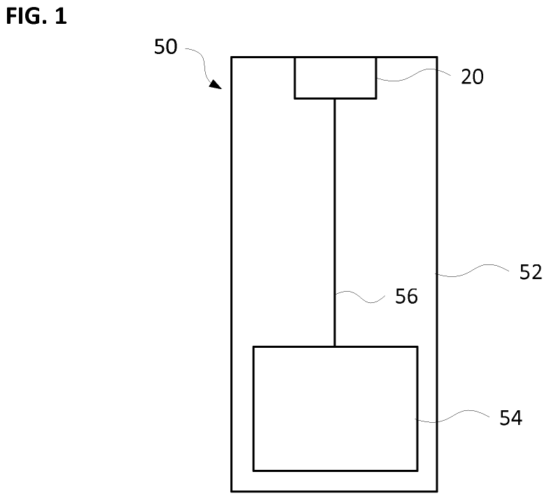

FIG. 1 shows a schematic lateral sectional view of a passenger transport system, for example an elevator system 50, according to an embodiment of the invention. The elevator system 50 has a elevator car 54 which is arranged vertically displaceably in an elevator shaft 52. The elevator system 50 has an elevator drive 20 of the type described above. The elevator drive 20 is arranged and designed such that the elevator car 54 can be displaced vertically in the elevator shaft 52 by the elevator drive 20, wherein the elevator drive 20 is mechanically coupled to the elevator car 54 via at least one support means 56, for example a steel cable.

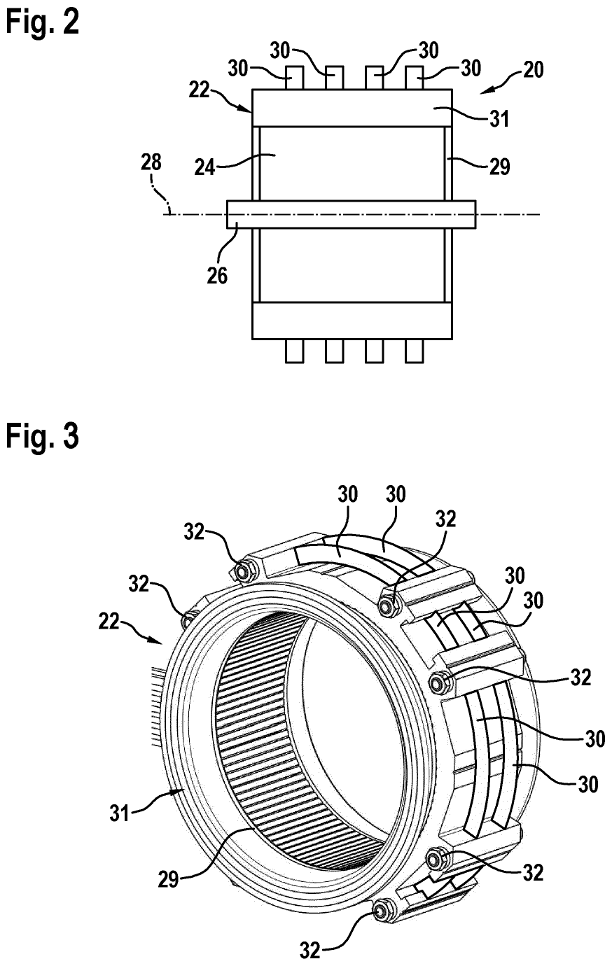

FIG. 2 is a schematic lateral sectional view of the elevator drive 20 according to an embodiment of the invention. The elevator drive 20 is suitable for example for use in a passenger transport system, such as the elevator system 50 (see FIG. 8), an escalator, or a moving walkway. The elevator drive 20 has a rotor 24, which is rotatably mounted about a axis of rotation 28 of the elevator drive 20, and a housingless stator 22. The stator 22 has a stator core 31 in which the rotor 24 is rotatably arranged, and one or more cooling fins 30 which are arranged on an outer surface of the stator core 31. The stator 22, in particular the stator core 31, has a stator recess 29 for receiving the rotor 24.

The stator 22 can also be called a “frameless stator.” The fact that the stator 22 is housingless means that the stator 22 is not arranged in a stator housing or housing of the elevator drive 20, which in turn is arranged on a corresponding base (not shown), but rather that the stator 22 is arranged directly on the base and/or that the elevator drive 20 does not have a housing, in particular no stator housing.

The elevator drive 20 can be an electric motor or a generator, or can be operated in both motor and generator mode. The elevator drive 20 can have a rotary shaft 26, such as a motor shaft or a generator shaft, which rotates about the axis of rotation 28. The rotor 24 can be connected to the rotating shaft 26 in a rotationally fixed manner. The rotary shaft 26, the rotor 24 and/or the stator 22 can be arranged concentrically to the axis of rotation 28. Furthermore, the rotor 24 and/or the stator 22 can have one or more windings (not shown), for example copper windings, in particular one or more rotor winding(s) or one or more stator winding(s).

The cooling fins 30 can be arranged directly on the stator core 31. The fact that the cooling fins 30 can be arranged “immediately,” in other words “directly,” on the stator core 31 means, for example, that it can be that no other body is situated between the cooling fins 30 and the stator core 31 and/or that the cooling fins 30 are formed integrally with the stator core 31, or at least integrally with one or more parts of the stator core 31, as explained in more detail below.

The cooling fins 30 can be designed and/or arranged so that they extend perpendicular to the axis of rotation 28. The cooling fins 30 can, for example, extend in the circumferential direction of the stator core 31. Alternatively, the cooling fins 30 can extend in the axial direction, depending on which embodiment has a stronger flow around the cooling fins 30 of the air in the environment of the elevator drive 20. Furthermore, the cooling fins 30 can be arranged parallel to each other. Both the orientation of the cooling fins 30 and a distance between the cooling fins 30 can be selected such that natural convection is utilized to ensure optimal air flow around the cooling fins 30.

End faces of the cooling fins 30 remote from the stator core 31 can each be at least 10 mm away from the stator core 31 in the radial direction, i.e., in the direction perpendicular to the axis of rotation 28. Concretely, the cooling fins 30 can each have a height of at least 10 mm. For example, the remote end faces of the cooling fins 30 can each be at a distance from the stator core 31 of between 10 mm and 100 mm, for example between 15 mm and 70 mm, or for example between 20 mm and 50 mm. In this context, an outer diameter of the stator 22 can be in a range of, for example, from 100 mm to 500 mm, for example approximately 200 mm.

FIG. 3 shows a perspective view of a stator 22 for an elevator drive 20 according to an embodiment of the invention, for example for the elevator drive 20 explained with reference to FIG. 1. The stator 22 has the cooling fins 30 on its outer surface. In this embodiment, the stator core 31 can be formed in one piece. In other words, this stator core 31 can be solid. Alternatively, the stator core 31 can be formed from metal rings arranged one inside the other, wherein the innermost metal ring forms the stator recess 29 and the outermost metal ring is coupled to the cooling fins 30.

The cooling fins 30 can be designed as explained with reference to FIG. 1. In particular, the cooling fins 30 can be formed integrally with the stator core 31 and/or can extend in the circumferential direction of the stator 22. For example, the stator core 31 or, if applicable, the outermost metal ring of the stator core 31 can be cast in such a way that the corresponding cast body also has the cooling fins 30. In other words, the stator core 31 and the cooling fins 30 can be formed in one piece. Alternatively, the cooling fins 30 can be attached directly to the stator core 31.

In the circumferential direction, multiple fastening recesses 34 can be formed between the cooling fins 30, through which fastening means 32 for fastening the stator 22 to the base can be guided.

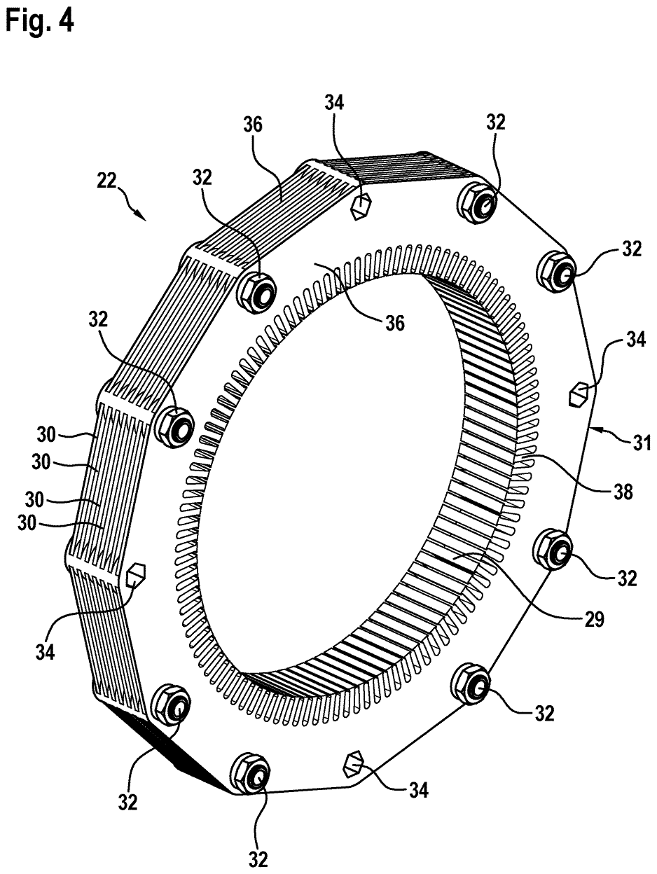

On a wall of the stator recess 29, multiple winding receptacles 38 (referenced in FIG. 4), for example in the form of slots, can be formed for receiving one or more stator windings (not shown). In this context, the elevator drive 20, in particular the stator 22, can have the stator winding(s). The stator windings can also be referred to as coils and/or can comprise copper, in particular can be formed from insulated copper wires.

FIG. 4 shows a perspective view of a stator 22 for an elevator drive 20 according to an embodiment of the invention, for example for the elevator drive 20 explained with reference to FIG. 1.

The stator core 31 can for example be formed from multiple metal layers 36, in particular metal sheets, for example iron sheets. The metal layers 36 can each have a thickness in a range for example from 0.1 mm to 1 cm, or for example from 0.3 mm to 0.65 mm. The metal layers 36 can be separated from each other by dielectric layers (not shown) to minimize eddy current losses induced by the magnetic alternating current. In the case of metal sheets, this can be achieved by applying an insulating varnish to both sides of the metal sheets. Alternatively, the metal layers 36 can be arranged directly next to one another. The metal layers 36 each have a layer recess of the corresponding metal layer 36, wherein the layer recesses together form the stator recess 29.

The metal layers 36 can each have multiple continuous fastening recesses 34 which are designed and arranged such that they are arranged congruently one behind the other when the metal layers 36 are arranged next to one another. If necessary, one of the fastening means 32, for example a screw or a pin, can be guided through each of the fastening recesses 34, for example in order to fasten the stator 22 to the base.

The metal layers 36 can be of the same design. The metal layers 36 having the same design can each have an enlarged outer diameter in individual outer regions. These similar metal layers 36 can be arranged offset from one another such that the regions with enlarged outer diameters of one of the similar metal layers 36 are each arranged in the axial direction next to regions with non-enlarged outer diameters of the corresponding adjacent similar metal layer 36. In the regions where the fastening recesses 34 are formed, metal layers 36 can have the same outer diameter. In the circumferential direction between these regions, the metal layers 36 can have the larger outer diameter and can form the cooling fins 30 there. Furthermore, in this embodiment, the cooling fins 30 are formed integrally with parts of the stator core 31, in particular with the metal layers 36.

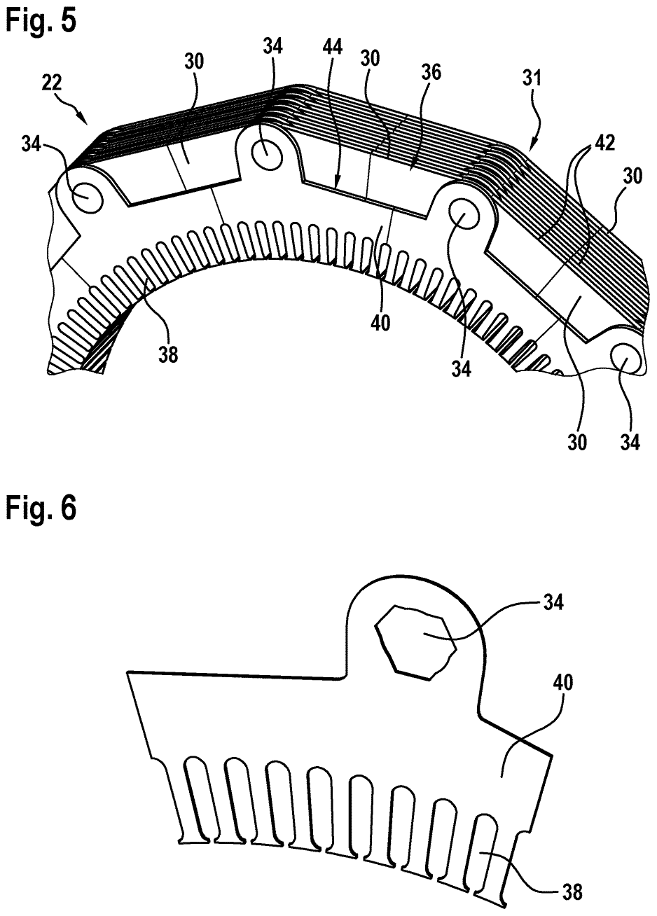

FIG. 5 shows a perspectival detail view of a stator 22 according to an embodiment of the invention. The stator 22 has the metal layers 36, referred to below as second metal layers 36, and first metal layers 44, which together form the stator core 31 and the cooling fins 30. The first metal layers 44 can have a first layer recess for receiving the rotor 24. The second metal layers 36 can each have a second layer recess for receiving the rotor 24. The size and shape of the second layer recesses can correspond to a size and shape of the first layer recesses.

The second metal layers 36 have, at least in some regions, a larger outer diameter than the first metal layers 44. The first and second metal layers 44, 36, respectively, can be arranged alternately one behind the other in the direction of the axis of rotation 28 such that the layer recesses are congruent with one another and such that the regions in which the second metal layers 36 have the larger outer diameter than the first metal layers 44 form the cooling fins 30. The layer recesses arranged congruently next to one another together form the stator recess 29, in which the rotor 24 can be arranged in a rotatable manner.

The second metal layers 36 are parts of the stator 22. The second metal layers 36 form the cooling fins 30 and are thus formed integrally with them. Thus, in this embodiment, the cooling fins 30 are formed integrally with the stator core 31, in particular integrally with parts of the stator core 31, in particular the second metal layers 36.

Optionally, the first and second metal layers 44, 36 are arranged directly adjacent to one another. In other words, it can be that no other components of the elevator drive 20 are situated between the first and second metal layers 44, 36, in particular in the axial direction of the axis of rotation 28. Alternatively, the dielectric layers mentioned above, in particular the insulating varnish, can be arranged between the respective first and second metal layers 44, 36.

Optionally, the first metal layers 44 can each be composed of multiple first metal segments 40, in particular in the circumferential direction, and/or the second metal layers 36 can each be composed of multiple second metal segments 42, in particular in the circumferential direction. For example, the first metal segments 40 can be arranged offset in the circumferential direction relative to the second metal segments 42 such that interfaces between the first metal segments 40 are offset relative to interfaces between the second metal segments 42. In other words, the metal segments 40, 42 can be arranged such that the interfaces between the first metal segments 40 are not arranged overlapping the interfaces between the second metal segments 42.

FIG. 6 shows a perspective view of an embodiment of one of the first metal segments 40 of one of the first metal layers 44 of the stator 22 according to FIG. 4. In particular, the first metal layers 44 can each comprise or be formed from multiple of these first metal segments 40. The first metal segments 40 can have the winding receptacles 38 for receiving the stator winding.

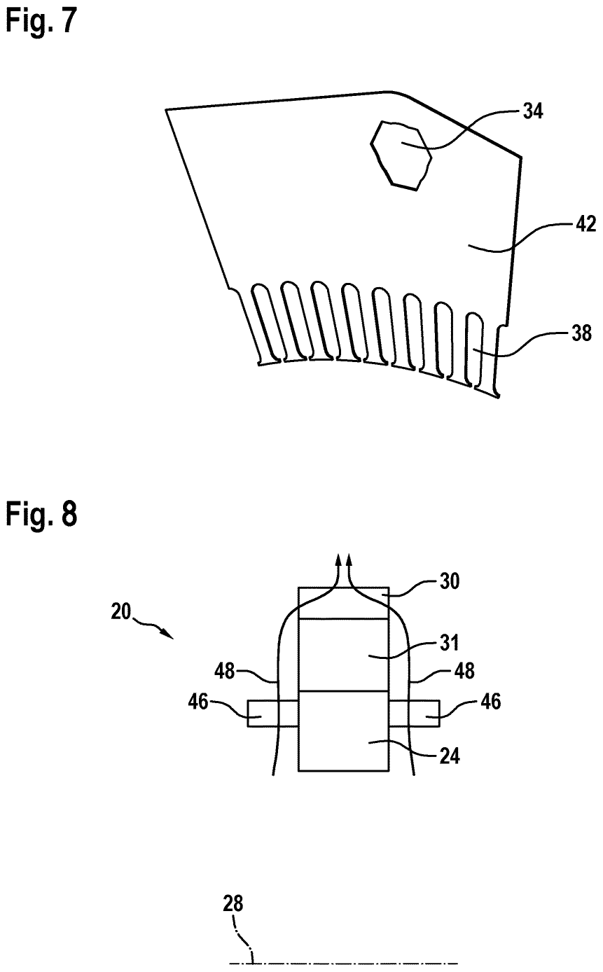

FIG. 7 shows a perspective view of an embodiment of one of the second metal segments 42 of one of the second metal layers 36 of the stator 22 according to FIG. 4. In particular, the second metal layers 36 can each comprise or be formed from multiple the second metal segments 42. The second metal segments 42 can have the winding receptacles 38 for receiving the stator winding.

FIG. 8 is a schematic lateral sectional view of an elevator drive 20 according to an embodiment of the invention. The elevator drive 20 can for example largely correspond to the elevator drive 20 explained with reference to FIG. 1 and/or can have one of the stators 22 explained with reference to FIG. 2, 3 or 4. Therefore, only those features of the elevator drive 20 shown in FIG. 7 are explained below, in which the elevator drive 20 differs from the elevator drive 20 explained with reference to FIG. 1.

The rotor 24 can have multiple vanes 46 which are arranged between the axis of rotation 28 and an outer circumference of the rotor 24 and which are designed to move air from the surroundings of the elevator drive 20 towards the stator 22, in particular towards the cooling fins 30, when the rotor 24 rotates. The rotor 24 with the vanes 46 can in particular be configured such that it acts like a fan which, when the rotor 24 rotates, moves the air outwards 48 towards the stator 22 or the cooling fins 30.

Furthermore, in this embodiment, the cooling fins 30 are formed parallel to the axis of rotation 28. Alternatively, the cooling fins 30 can be formed perpendicular to the axis of rotation 28 and in the circumferential direction, as shown in FIG. 2. Furthermore, the cooling fins 30 can also be formed obliquely, i.e., in terms of their orientation, between the orientation shown in FIG. 1 and the orientation shown in FIG. 8.

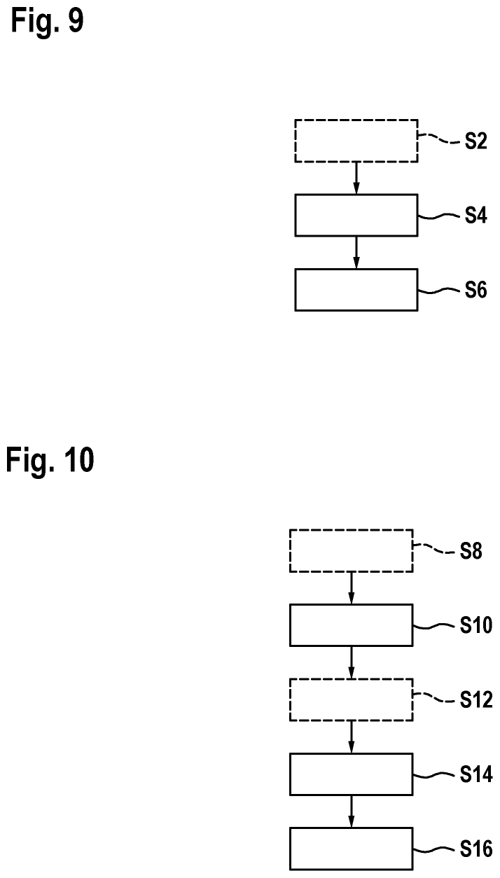

FIG. 9 shows a flowchart of an embodiment of a method for producing a stator 22, for example the stator 22 according to FIG. 3.

In an optional step S2, the similar metal layers 36 can be provided by forming and assembling corresponding metal segments 42 which together form the corresponding metal layer 36. The metal segments 42 can for example be punched, milled, sawed or cut out from appropriate metal sheets.

In a step S4, the similar metal layers 36 can be provided. The similar metal layers 36 can each have regions with a first outer diameter and regions with a second outer diameter, wherein the second outer diameter is larger than the first outer diameter. The similar metal layers 36 can for example be punched, milled, sawed or cut out from appropriate metal sheets. In this case, the similar metal layers 36 can each be formed in one piece. Alternatively, the similar metal layers 36 can be provided by step S2. The similar metal layers 36 can be formed such that they each have the layer recess for receiving the rotor 24.

In a step S6, the similar metal layers 36 can be arranged one behind the other in the direction of the axis of rotation 28 such that their layer recesses are congruent with one another and that the regions with the first outer diameters of one of the similar metal layers 36 are arranged in the direction of the axis of rotation 28 next to regions with the second outer diameters of a corresponding adjacent one of the similar metal layers 36, wherein the cooling fins 30 are formed by the regions with the second outer diameters. The similar metal layers 36 arranged next to one another together form the stator core 31 and the cooling fins 30 of the stator 22. The similar metal layers 36 can be arranged immediately next to one another.

If the similar metal layers 36 are composed of the corresponding metal segments 42, the similar metal layers 36 can be arranged relative to one another such that the metal segments 42 are arranged offset in the circumferential direction relative to the metal segments 42 of adjacent metal layers 36, such that the interfaces between the metal segments 42 are offset relative to the interfaces between the metal segments 42 of the adjacent metal layers 36.

Finally, if necessary the stator windings can be attached to the stator 22, in particular in the winding receptacles 38.

FIG. 10 shows a flowchart of an embodiment of a method for producing a stator 22, for example the stator 22 according to FIG. 4.

In an optional step S8, the first metal layers 44 can be provided by forming and assembling the multiple first metal segments 40 that together form the corresponding first metal layer 44. The metal segments 40 can for example be punched, milled, sawed or cut out from appropriate metal sheets. The step S8 can be carried out in particular when the first metal layers 44 are composed of the first metal segments 40.

In a step S10, multiple the first metal layers 44 can be provided. The first metal layers 44 can for example be punched, milled, sawed or cut out from appropriate metal sheets. In this case, the first metal layers 44 can each be formed in one piece. Alternatively, the first metal layers 44 can be provided by means of step S8. The first metal layers 44 can be formed such that they each have the first layer recess for receiving the rotor 24.

In an optional step S12, the second metal layers 36 can be provided by forming and assembling the multiple second metal segments 42 that together form the corresponding second metal layer 36. The second metal segments 42 can for example be punched, milled, sawed or cut out from appropriate metal sheets. Step S12 can be carried out in particular when the second metal layers 36 are composed of the second metal segments 42.

In a step S14, multiple of the second metal layers 36 can be provided. The second metal layers 36 can for example be punched, milled, sawed or cut out from appropriate metal sheets. In this case, the second metal layers 36 can each be formed in one piece. Alternatively, the second metal layers 36 can be provided by means of step S6. The second metal layers 36 can be formed such that they each have the second layer recess for receiving the rotor 24. The second metal layers 36 can each have the second layer recess for receiving the rotor 24, the size and shape of which corresponds to the size and shape of the first layer recesses. The second metal layers 36 can be formed such that they have, at least in some regions, a larger outer diameter than the first metal layers 44.

In a step S16, the first and second metal layers 44, 36, respectively, can be arranged alternately one behind the other in the direction of the axis of rotation 28 such that their layer recesses are congruent with one another, wherein the regions in which the second metal layers 36 have the larger outer diameter than the first metal layers 44 form the cooling fins 30. The respective first and second metal layers 44, 36 arranged next to one another together form the stator core 31 and the cooling fins 30 of the stator 22. The first and second metal layers 44, 36 can be arranged immediately next to one another.

If the first and second metal layers 44, 36 are composed of the corresponding metal segments 40, 42, the first and second metal layers 44, 36 can be arranged relative to one another such that the first metal segments 40 are offset in the circumferential direction relative to the second metal segments 42 such that the interfaces between the first metal segments 40 are offset relative to the interfaces between the second metal segments 42.

Finally, if necessary the stator windings can be attached to the stator 22, in particular in the winding recesses 38.

Finally, it should be noted that terms such as “comprising,” “having,” etc. do not exclude other elements or steps, and terms such as “a” or “an” do not exclude a plurality. Furthermore, it should be noted that features or steps that have been described with reference to one of the above embodiments can also be used in combination with other features or steps of other embodiments described above.

1.-19. (canceled)

20. An elevator system, comprising:
an elevator shaft;
a elevator car disposed in the elevator shaft;
at least one counterweight disposed in the elevator shaft and coupled to the elevator car via at least one support;
at least one elevator drive; and
a brake to at least one of brake or lock at least one of the elevator car or the at least one counterweight;
wherein the at least one support extends over and is movable by the elevator drive; and
wherein the elevator car and the at least one counterweight are displaced vertically by operating the elevator drive.

21. The elevator system according to claim 20, wherein the elevator drive includes a stator without a housing, the stator including a stator core having a stator recess for receiving a rotor of the elevator drive, and one or more cooling fins disposed on an outer surface of the stator core.

22. The elevator system according to claim 21, wherein the one or more cooling fins are disposed directly on the stator core.

23. The elevator system according to claim 21, wherein the stator recess is rotationally symmetrical to an axis of rotation of the elevator drive, and wherein the cooling fins extend perpendicular to the axis of rotation.

24. The elevator system according to claim 21, wherein at least a portion of the stator core and the one or more cooling fins are integrally formed as one monolithic structure.

25. The elevator system according to claim 23, wherein the stator has a plurality of metal layers forming the stator core and the one or more cooling fins, wherein the metal layers each have a layer recess, wherein the metal layers are alternately arranged in the direction of the axis of rotation, wherein the layer recesses of the metal layers are congruent with one another and together form the stator recess, wherein alternating ones of the metal layers include at least one region having a larger outer diameter than an adjacent one of the metal layers, and wherein the at least one region of the metal layers having the larger outer diameter form the one or more cooling fins.

26. The elevator system according to claim 25, wherein the metal layers are arranged directly adjacent to one another.

27. The elevator system according to claim 25, wherein each of the metal layers includes a plurality of metal segments.

28. The elevator system according to claim 27, wherein the metal segments of one of the metal layers are arranged offset in a circumferential direction to the metal segments of the adjacent one of the metal layers, and wherein interfaces between the metal segments of the one of the metal layers are offset relative to interfaces between the metal segments of the adjacent one of the metal layers.

29. The elevator system according to claim 25, wherein the metal layers include first metal layers and second metal layers alternately arranged, wherein the second metal layers include at least one region having a larger outer diameter than the first metal layers, and wherein the at least one region of the second metal layers having the larger outer diameter form the one or more cooling fins.

30. The elevator system according to claim 25, wherein each of the metal layers is identical and includes one or more first regions having a first outer diameter and one or more second regions having a second outer diameter, wherein the second outer diameter is larger than the first outer diameter, wherein the metal layers are arranged adjacent to one another such that one of the metal layers including the one or more first regions having the first outer diameter is arranged in the direction of the axis of rotation adjacent to one of the metal layers including the one or more second regions having the second outer diameter, and wherein the one or more second regions having the second outer diameter form the one or more cooling fins.

31. The elevator system according to claim 29, wherein each of the first metal layers is substantially identical to one another, wherein each of the second metal layers is substantially identical to one another, and wherein the first metal layers are different from the second metal layers.

32. The elevator system according to claim 31, wherein an outer contour of each of the first metal layers and an outer contour of each of the second metal layers is different in a direction parallel to the axis of rotation.

33. The elevator system according to claim 21, wherein the one or more cooling fins dissipate heat to a gaseous cooling medium in direct contact with the stator, and wherein the gaseous cooling medium is air.

34. The elevator system according to claim 23, wherein each of the one or more cooling fins is substantially continuously circumferential in a circumferential direction relative to the axis of rotation.

35. The elevator system according to claim 20, the electric drive including a stator without a housing and a rotor rotatably mounted about an axis of rotation of the elevator drive, wherein the rotor is rotatably disposed in a stator recess of the stator.

36. The elevator system according to claim 35, wherein the rotor includes a plurality of vanes disposed between the axis of rotation and an outer circumference of the rotor, wherein the vanes move air towards the stator.

37. A method for producing an elevator system with an elevator drive, the method comprising:
providing a plurality of metal layers, each of the metal layers having a layer recess; and
arranging the metal layers in an alternating relationship, wherein the layer recesses if the metal layers are congruent with one another and together form a stator recess for receiving a rotor of the elevator drive;
wherein alternating ones of the metal layers include at least one region having a larger outer diameter than an adjacent one of the metal layers, and wherein the at least one region of the metal layers having the larger outer diameter form the one or more cooling fins; and
wherein the metal layers arranged next to one another form a stator core of the stator.

38. The method according to claim 37, wherein the metal layers include first metal layers and second metal layers alternately arranged, wherein the second metal layers include at least one region having a larger outer diameter than the first metal layers, and wherein the at least one region of the second metal layers having the larger outer diameter form the one or more cooling fins.

39. The method according to claim 37, wherein each of the metal layers is identical and includes one or more first regions having a first outer diameter and one or more second regions having a second outer diameter, wherein the second outer diameter is larger than the first outer diameter, wherein the metal layers are arranged adjacent to one another such that one of the metal layers including the one or more first regions having the first outer diameter is arranged in the direction of the axis of rotation adjacent to one of the metal layers including the one or more second regions having the second outer diameter, and wherein the one or more second regions having the second outer diameter form the one or more cooling fins.
